(19) United States
(12) Patent Application Publication
(10) Pub. No.: US 2006/0168001 A1
(43) Pub. Date: Jul. 27, 2006

(54) Web site presence detector

(76) Inventors: Thomas Maher Lasater, Matheson, CO (US); Greg Junell, San Luis Obispo, CA (US); Marcos R. Della, Scotts Valley, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/260,035

(22) Filed: Oct. 25, 2005

Related U.S. Application Data
(60) Provisional application No. 60/621,786, filed on Oct. 25, 2004.

(51) Int. Cl. G06F 15/16

(52) U.S. Cl. 709/205

(57) ABSTRACT

The present invention provides systems and methods for initiating relevant communication (e.g., text, voice, video, etc) based on a shared experience. Each client in a system includes a presence detector which provides information about a user experience. The information can include, for example, web pages viewed by the user, content metadata associated with the web page, a location of the user, software applications in use by the user, and the like. A centralized server in the system can quantify the proximity between experiences of two users can be quantified with a correlation score. If the users exceed a predetermined threshold for the correlation score, they can be connected into, fore example, a chat room or video conference.

### CROSS-REFERENCE TO RELATED APPLICATION

This application claims priority under 35 U.S.C. §119(e) to U.S. Provisional Patent Application No. 60/621,786, filed on Oct. 25, 2004, entitled WEB SITE PRESENCE DETECTOR by Thomas M. Lasater, the contents of which are herein incorporated by reference in its entirety.

### FIELD OF THE INVENTION

The present invention relates generally networks, and more specifically, to social networking over a network based on shared user experiences.

### BACKGROUND

Interactive communications between computer users (or users of other devices), distinct from delayed communications such as e-mail, has grown to become a significant part of culture. Interactive communications can take place over the Internet in chat rooms, or over a cellular phone, using SMS messaging. Various types of interaction are possible. For example, two or more friends can form a private chat room to discuss various topics. On the other hand, visitors to a web site on a specific topic can join other visitors to the web site to discuss specific topics. However, in the private chat room, the topic of conversation is merely social and can lack relevance to either participant.

A computer user is often alone while viewing web sites on the Internet. For example, a computer user researching an interest in model trains may not share have social friends, or chat buddies, with the same interest. Even if such friends exist, deliberate action is necessary with respect to being online and available at the same time. Finding topic-specific chat rooms can be challenging as well. Furthermore, as a user experience changes, for example, by changing topics of research, the user has to repeat the search for a relevant chat room.

Therefore, there is a need for a system and method that generates chat rooms based and other interactions on a current user experience, such as a web page being viewed or physical location.

### SUMMARY

A system and method for initiating relevant communication (e.g., text, voice, video, etc) based on a shared experience is provided. The proximity between experiences of two users can be quantified with a correlation score. If the users exceed a predetermined threshold for the correlation score, they can be connected into, fore example, a chat room or video conference.

In one embodiment, a system includes several clients and central server. Each client includes a presence detector which provides information about a user experience. The information can include, for example, web pages viewed by the user, content metadata associated with the web page, a location of the user, software applications in use by the user, and the like.

Advantageously, two people having similar user experiences are given the same presence.

### BRIEF DESCRIPTION OF THE DRAWINGS

FIG. 1 is a flow chart illustrating a method for joining a chat room based on proximity in web surfing experiences according to one embodiment of the present invention.

FIG. 2 is a flow chart illustrating a method for creating a chat room based on proximity in web surfing experiences according to one embodiment of the present invention.

FIG. 3 is a flow chart illustrating a method for determining user proximities when creating the chat room according to one embodiment of the present invention.

FIG. 4 is a block diagram illustrating a system for creating chat rooms based on proximity in web surfing experiences according to one embodiment of the present invention.

FIG. 5 is a block diagram illustrating a presence module in the system according to one embodiment of the present invention.

FIG. 6 is a schematic diagram illustrating a web browser in the system with an integrated chat module according to one embodiment of the present invention.

FIG. 7 is a block diagram illustrating a central server in the system according to one embodiment of the present invention.

One skilled in the art will recognize that these Figures are merely examples of the operation of the invention according to one embodiment and that other configurations and modes of operation can be used without departing from the essential characteristics of the invention.

### DETAILED DESCRIPTION

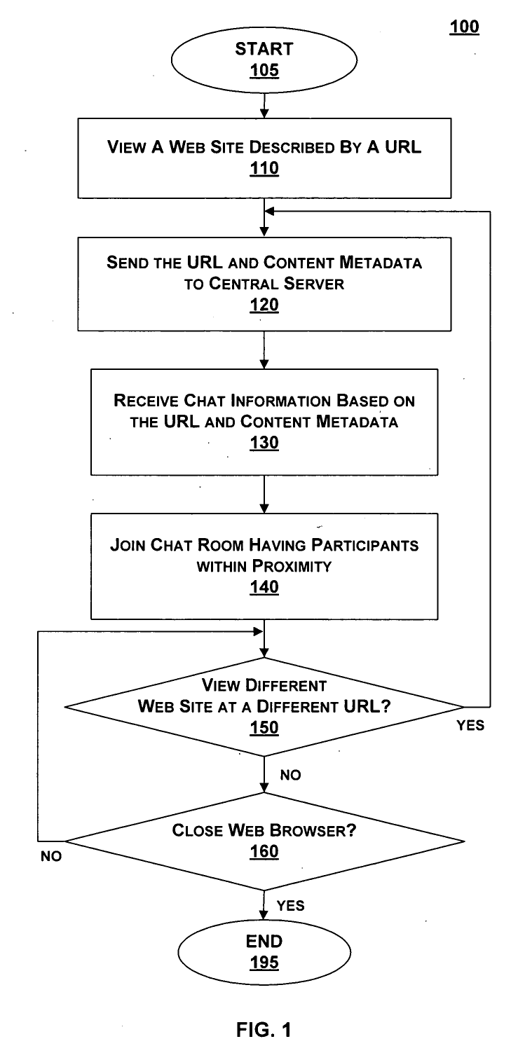

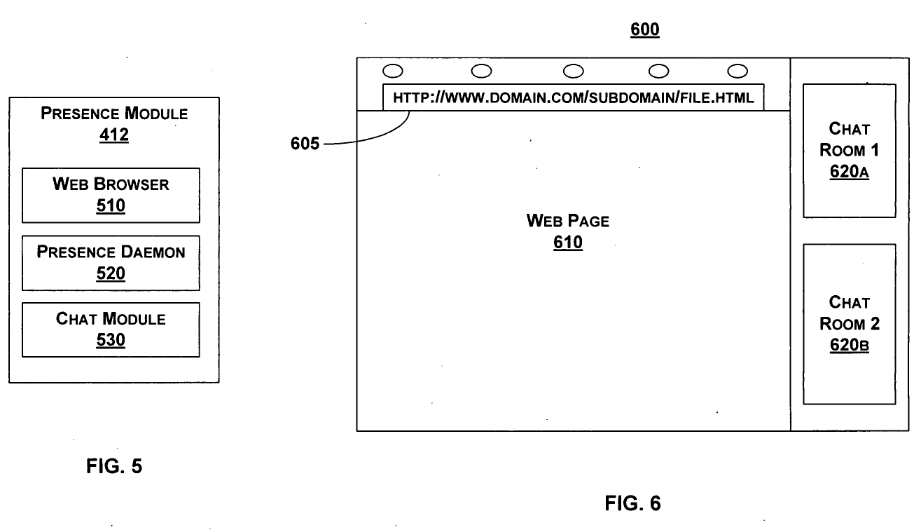

Systems and methods for connecting users in a chat room based on shared experiences. The methods illustrated in FIGS. 1-4 can be implemented, in some embodiments, by the systems illustrated in FIGS. 5-7. The user connections can be based on proximity in web surfing. Also, the user connections can be based on proximity in physical locations. Proximity can be determined objectively by, for example, a URL associated with a web page being viewed or a physical location. Proximity can also be determined subjectively by, for example, personal settings or influences from a social network of other users. Additional sources for determining user proximity, such as users listening to the same audio or video (locally or over the web), which also define shared experiences, are within the scope of the present invention.

FIG. 1 is a flow chart illustrating a method 100 for joining a chat room based on proximity in web surfing experiences according to one embodiment of the present invention. Generally, the method 100 describes interactions as experience by a client, such as the client described in association with FIG. 5.

A user of a client can view 110 a web site described by a URL. The web site can be stored on a web server that can be reached on the Internet using the URL. The URL can include a domain name, and optionally a subdomain and/or file name. The domain name is the top-level description of a web site while the subdomain and file name point to particular file locations within the domain name.

The URL and content metadata is sent 120 to a central server such as the central server described below. The content metadata can be a description of the web page such as one or more keywords. The keywords can be derived from classifications on a search engine, embedded tags, an analysis of text on the page, or other metadata (e.g., del.icio.us tags). For example, a user viewing a web page about ‘cars’ can have the experience generalized by categorizing the web page as ‘motor vehicles’ in order to provide more connection opportunities. In one embodiment, keywords can be determined contacts in a social network. For example, when contacts visit a page, they can leave note or a description about the content which can be used as content metadata. A user can set parameters to manage inputs for content metadata.

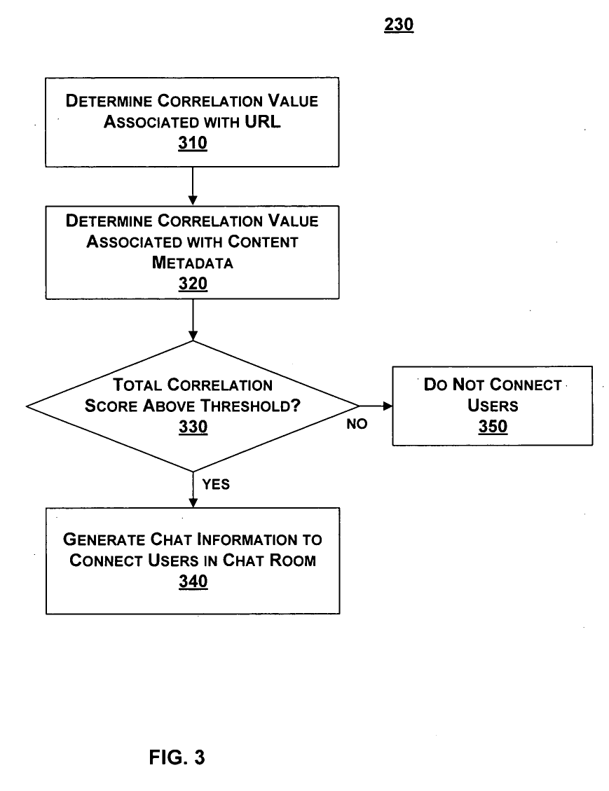

After the central server processes the URL and content metadata, chat information is received 130 by the client. The chat information allows a user to join a chat room with, for example, a URL or identification of the chat room. The chat information can be determined by a proximity of the user to other users as described below in association with FIG. 3.

The user can then join 140 the chat room of participants having similar user experiences. That is, the chat room can include users viewing the same or similar web pages. If a user views a different web site at a different URL 150, a new or additional chat room can be made available. In one embodiment, the chat rooms are available until the web browser is closed 160. In another embodiment, the user can toggle the service on and off.

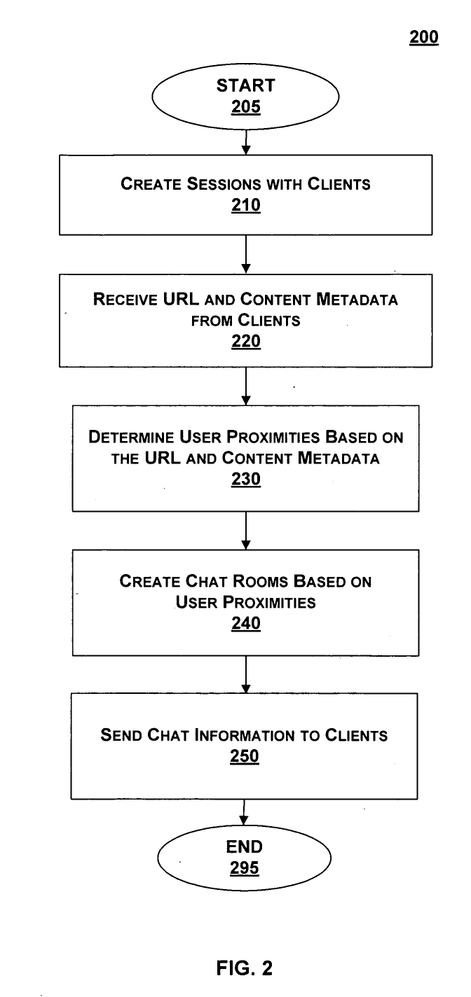

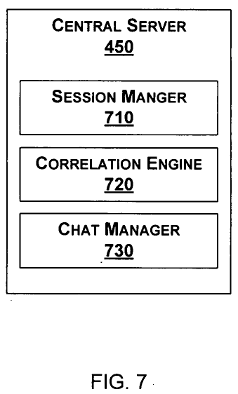

FIG. 2 is a flow chart illustrating a method 200 for creating a chat room based on proximity in web surfing experiences according to one embodiment of the present invention. Generally, the method 200 describes interactions as experience by a central server, such as the client described in association with FIG. 7.

Sessions are created 210 with clients in response to receiving a connection request. Identification information such as an IP address or serial number can be associated with a session between the central server and each client. The session can be set-up according to a communication protocol (e.g., TCP/IP, Bluetooth, etc.)

URLs and content metadata are received 220 over the sessions while a user views web pages. The information can be used immediately, or stored in a cache to create a history or identify user habits. Based on this information, user proximities are determined 230 as described below in association with FIG. 3. Essentially, user proximity is a metric used to couple users that are having a similar user experience.

A chat room is created 240 to connect proximate users. The chat room can be initially created for the first two users, and later offered to additional qualifying users. The chat room can be hosted by third-party service. Chat information is sent 250 to the clients, thereby allowing the clients to join in relevant discussion.

FIG. 3 is a flow chart illustrating the method 230 for determining user proximities when creating the chat room according to one embodiment of the present invention. A correlation value can be associated 310 with the URL received from the clients. Correlation values can be implemented using various methods, the following of which are only illustrations. Correlation values can be determined by a number of clients currently (or historically) viewing a web site. For example, the number of users currently viewing www.espn.com can have a high correlation value if above below 10 and a low value if above 100. Correlation values can be determined at various levels within a URL. For example, at a single moment, the correlation value for www.espn.com/golf is likely to be higher than www.espn.com. Correlation values can constantly change, based on recent activities by clients. For example, www.espn.com/golf can experience high traffic immediately before a golf tournament, and thus, become less relevant as a commonality between users during that time.

A correlation value can be associated 310 with content metadata. The content metadata allows viewers of similar sites to be connected. For example, viewers of www.espn.com/tennis are likely to have common interests with viewers of www.tennis.com. In one embodiment, quantitative factors can be used as with the URL correlation values. In other embodiments, qualitative factors can be used such as social network influences. Content metadata can be received from sources other than clients, such as from third parties. In response to submitting the URL to a service such as http://del.icio.us, related media tags can be retrieved.

Whether or not two users are connected can be determined by a total correlation score being above a threshold 330. The total correlation score can be, for example, a sum of correlation values. Note that various combinations of correlation values are possible, including the use of a single correlation value as a correlation score. In one embodiment, user preferences can dictate a minimum correlation score, or commonality of user experience. In response to surpassing the threshold, a chat room is generated 340 to connect the users. Otherwise, the users are not connected 350.

In one embodiment, factors used in determining the correlation score can be presented to the user for feedback. For example, the user can be presented with several keywords derived from a web page, and the user can choose or weight the keywords, thereby effecting their impact on the correlation score.

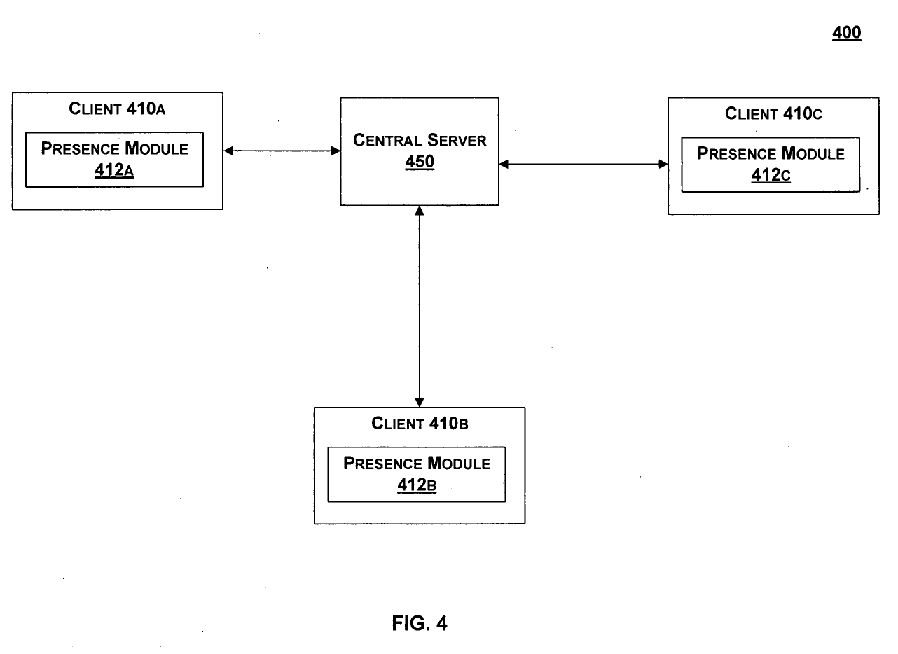

FIG. 4 is a block diagram illustrating a system 400 for creating chat rooms based on proximity in web surfing experiences according to one embodiment of the present invention. The system 400 includes one or more clients 410a-c in communication with a central server 450. Communication can occur over a medium such as a data network using TCP/IP or other protocols, a telephone or cellular network, a hybrid network, and the like.

The client 410 can be a device such as a personal computer, PDA, telephone or other device with a display screen. In one embodiment, the clients 410a-c include presence modules 412a-c. The presence module 412 tracks a user experience by observing URL requests and other activities at the client 410. The presence module 412 exchanges information with the central server 450 to identify other users for shared experiences (e.g., other users viewing the same web page or using the same software application).

The central server 450 can be, for example, a device such as a personal computer or server blade running software. The central server 450 allows users to have shared experiences by evaluating proximities between users. In one embodiment, the central server 450 connects sufficiently proximate users in a chat room.

FIG. 5 is a block diagram illustrating the presence module 412 in the system according to one embodiment of the present invention. The presence module 412 comprises a web browser 510, a presence daemon 520, and a chat module 530.

The web browser 510 can be, for example software code such as Firefox or Internet Explorer. The browser 510 allows a user to load various web pages on the World Wide Web by requesting URLs.

The presence daemon 520 can be an independent software module, or an enhancement to the web browser 510 or an operating system (not shown). The presence daemon 510 detects when the web browser 510 or other observed application is launched and closed, in order to set-up and tear-down sessions with the central server 450. The presence daemon 510 collects and sends information such as URLs requested by the web browser 510 or content metadata.

The chat module 530 can be a plug-in, javascript frames, or other module operating as a stand-alone application or as an enhancement to the web browser 510. The chat module 530 allows users at different locations around a network to send and receive messages. Messages can be text, voice, or video.

FIG. 6 is a schematic diagram illustrating a web browser 600 in the system 400 with integrated chat rooms 620a,b according to one embodiment of the present invention. Also in the web browser 600, a URL is entered into a data field 605 and a web page 610 is displayed. The web browser 600 is merely exemplary as many variations are possible.

FIG. 7 is a block diagram illustrating the central server 450 in the system 400 according to one embodiment of the present invention. The central server 450 comprises a session manager 710, a correlation engine 720, and a chat manager 730.

The session module 710 sets up communications with the clients 410a-c. The session module 710 can receive and store an IP address or other identifying information. The session module 710 can assign a specific port that is dedicated to the session.

The correlation module 720 determines proximity between users in order to facilitate relevant communications. For example, the correlation module 720 can connect several users that are currently viewing the same URL as described above. In one embodiment, the correlation module 720 can use other metadata associated with a web page such as genre, category, and the like.

The chat manager 730 controls the creation of chat rooms between users that are sufficiently correlated. To do so, the chat module 730 can send a chat room identifier to each client 410 which, in response, joins the identified chat room.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it may prove convenient to construct more specialized apparatuses to perform the method steps. The required structure for a variety of these systems will appear from the description below. In addition, the present invention is not described with reference to any particular programming language. It will be appreciated that a variety of programming languages can be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A method for generating a chat room from common user experiences, comprising:
receiving URL information and content metadata from a plurality of clients that each has an active web browser;
determining a proximity between a first client and a second client from a correlation score based on the URL information and content metadata; and
responsive to the proximity being above a predetermined threshold, providing chat room information that allows a chat room connection between at least the first and second clients.

2. The method of claim 1, further comprising:
assigning a correlation value to a URL in accordance with a number of clients currently visiting the URL.

3. The method of claim 1, wherein the content metadata comprises one or more keywords associated with a web page at the URL.

4. The method of claim 1, further comprising:
assigning a correlation value to content metadata in accordance with a number of clients currently associated with the content metadata.

5. The method of claim 4, further comprising:
determining the number of clients currently associated with the content metadata from a third party database.

6. The method of claim 1, further comprising:
receiving the predetermine threshold from either of the first or second clients.

7. The method of claim 1, further comprising:
creating a chat room that is available to the first and second clients.

8. The method of claim 1, further comprising:
receiving location information from the clients,
wherein determining the proximity includes determining the proximity based on the location information.

9. A method for finding a chat room with users having common user experiences, comprising:
requesting a web page described by a URL;
sending URL information and content metadata associated with the request to a central server;
receiving chat room information that is based on a proximity between a first client and a second client, the proximity being determined by a correlation score based on the URL information and content metadata; and
joining a chat room associated with the chat room information.

10. The method of claim 9, further comprising:
determining the content metadata by deriving keywords from the web page.

11. The method of claim 9, wherein joining the chat room comprises:
joining the chat room while viewing the web page.

12. The method of claim 9, further comprising:
receiving a user request to stop; and
discontinuing the sending URL information and content metadata.

13. The method of claim 9, further comprising:
requesting a second web page described by a URL; and
sending second URL information and content metadata.

14. The method of claim 9, further comprising:
determining location information from current coordinates; and
sending the location information to the central server.

15. A central server for generating a chat room from common user experiences, comprising:
a correlation engine to receive URL information and content metadata from a plurality of clients that each has an active web browser, the correlation engine configured to determine a proximity between a first client and a second client from a correlation score based on the URL information and content metadata, and responsive to the proximity being above a predetermined threshold, the correlation engine configured to provide chat room information that allows a chat room connection between at least the first and second clients.

16. The central server of claim 15, wherein the correlation engine assigns a correlation value to a URL in accordance with a number of clients currently visiting the URL.

17. The central server of claim 15, wherein the content metadata comprises one or more keywords associated with a web page at the URL.

18. The central server of claim 15, wherein the correlation engine assigns a correlation value to content metadata in accordance with a number of clients currently associated with the content metadata.

19. The central server of claim 15, wherein the correlation engine creates a chat room that is available to the first and second clients.

20. A device for finding a chat room with users having common user experiences, comprising:
a web browser to request a web page described by a URL;
a presence daemon to send URL information and content metadata associated with the request to a central server; and
a chat module to receive chat room information that is based on a proximity between a first client and a second client, the proximity being determined by a correlation score based on the URL information and content metadata, the chat module configured to join a chat room associated with the chat room.

21. The device of claim 20, further comprising:
a global positioning module to determine location information, wherein the presence daemon sends the location information to the central server to use in determining the correlation score.

22. The device of claim 20, wherein the device comprises one from the group comprising: a personal computer, a laptop computer, a PDA, and a telephone.
